(19) United States
(12) Patent Application Publication
(10) Pub. No.: US 2013/0047434 A1
(43) Pub. Date: Feb. 28, 2013

(54) TOOL FOR MOUNTING STUD BOLTS

(71) Applicants: Trent A. Ivesdal, Grand Forks, ND (US); Joshua E. Anderson, Grand Forks, ND (US)

(72) Inventors: Joshua D. Gregorich, Grand Forks, ND (US); Trent A. Ivesdal, Grand Forks, ND (US); Joshua E. Anderson, Grand Forks, ND (US)

(73) Assignee: LM GLASFIBER A/S, Kolding (DK)

(21) Appl. No.: 13/500,228

(22) PCT Filed: Oct. 5, 2010
(86) PCT No.: PCT/DK2010/050251

§ 371 Date: Aug. 24, 2012

(30) Foreign Application Priority Data
Oct. 5, 2009 (DK) PA 2009 70146

(51) Int. Cl. B25B 13/50; B23P 11/00

(52) U.S. Cl. 29/889.7; 81/53.2; 29/456

(57) ABSTRACT

The invention concerns a tool (1), a method and use of such a tool (1) for mounting stud bolts (12). The tool (1) is intended for use in connection with a drive, preferably a hand held drive, and is provided with a threaded part (4) that interacts with the threaded end (14) of the stud bolt during mounting of the stud bolt (12). The threaded part (4) is the part forming mechanical connection to a stud bolt (12) and which during mounting of the stud bolt (12) serves as operating measure. In a preferred variant of a tool (1) according to the invention, the threaded part (4) is made conical. By making a conical screw thread there is achieved the advantage that the engagement between stud bolt (12) and tool (1) is imparted low frictional resistance.

### FIELD OF THE INVENTION

The present invention concerns a tool for mounting a stud bolt with a first threaded end and with a second threaded end, where the first threaded end is intended for mounting in threaded holes adapted therefor in a workpiece, where the tool is intended for use in connection with a drive, preferably a handheld drive, and including a threaded part, where the threaded part interacts with the second threaded part of the stud bolt during mounting of the stud bolt. The invention furthermore concerns a method for mounting stud bolts with such a tool, and use of a method and a tool for mounting stud bolts.

### BACKGROUND OF THE INVENTION

It is commonly known to use various forms of tools in connection with mounting stud bolts, reinforcing bolts, threaded rods, staybolts etc. In the following, the different bolt types will all be termed stud bolts, the term in this context covering both mentioned and unmentioned types of bolts that have a screw thread at both ends or are threaded in the entire length of the bolt.

Such bolts are used for many purposes, but mounting these stud bolts in threaded holes obviously pose a challenge since they are provided with screw thread at both ends, why traditional tools intended for traditional procedures cannot be used.

Over the years, various solutions to this problem has thus been developed; however the greatest focus has seemingly been on tools for dismounting such stud bolts rather than mounting them. Typically, mounting will be effected manually in that two nuts are tightened in mutually reverse directions at one threaded end of the stud bolt, after which one or both nuts are used in the same way as a traditional bolt head during mounting. The mounting may occur by manual tools or by powered tools, for example pneumatic tools or electric tools.

Many of these stud bolts are to be mounted in such a way that they are screwed to the bottom of the threaded hole, entailing that the mounting itself of stud bolts is a process which does not demand any accuracy. Another much used mounting method for stud bolts is to mount them in a workpiece until one threaded part of the stud bolt is entirely screwed into the workpiece. Therefore, it is not required here either to check how long the stud bolt is screwed in since it is determined by the remaining structure.

In some places it is of decisive importance to position stud bolts with great precision, and such a solution is disclosed in U.S. Pat. No. 6,164,164. However, this solution is slow and developed for a very exact disposition of the stud bolt, and is not suited for industrial use where many stud bolts are to be fitted with a tolerance with an accuracy within about one millimetre, without having to mount each individual stud bolt in the tool and screw it manually into a threaded hole.

From DE 200 11 599 U1 is known a tool for mounting screws without heads, e.g. the kind of screws used in connection with mounting radiators and some sanitary installations. The tool is provided with a threaded hole in which the screw thread is received. When the screw is fixed in a wall or similar, the tool is brought to rotate the opposite direction, and the screw remains in the wall if the friction is greater in the wall than in the tool, which often appears to be a problem, entailing that one cannot be sure if the screw is partly loosened after removing the tool.

### OBJECT OF THE INVENTION

It is the object of the invention to indicate a solution for mounting stud bolts where the solution is suitable for industrial use, in particular for stud bolts with a diameter of 20 mm or more, where the stud bolts are to be mounted rapidly and with adequate accuracy.

### DESCRIPTION OF THE INVENTION

As mentioned above, the invention concerns a tool, a method and use of such a tool for mounting stud bolts. In a preferred variant of the tool according to the invention, the threaded part of the tool is made conical, where the conicity has an angle of 5-10°, but in a preferred embodiment with an angle of about 7°. By providing a conical screw thread there is achieved the advantage that the engagement between stud bolt and tool has low frictional resistance while the required moment can be transmitted to the stud bolt at the same time. The required moment may be different for different types of stud bolts, depending on the design of the thread and on whether a kind of glue is used for securing the stud bolt in the mounted position.

The thread in the tool can be designed conical in such a way that the end of the tool where the second end of the stud bolt is inserted at first is provided with the least diameter of the thread, by which is achieved a very small contact surface between tool and stud bolt. Due to the very small contact area in the two screw threads, there is only need for a relatively small moment in order to loosen the tool from the mounted stud bolt. As mentioned, this is achieved without problems by letting the applied handheld drive rotate for a very short time in opposite direction relative to the direction during mounting of the stud bolt.

In addition to a threaded part, the tool according to the invention includes at least one spacer member and means for connection to the drive for making the tool rotate. The threaded part is the part providing mechanical connection to a stud bolt and which during mounting of the stud bolt serves as operating measure. The spacer member implies the advantage that the tool can be driven until this spacer member abuts on either the workpiece or a matrix holding the stud bolt during mounting. By the spacer member is achieved a uniform mounting of the stud bolts and at the same time a rapid process since there is no need for checking the position of the stud bolt with measuring tools. When the spacer member abuts on the surface in relation to which the entire design of workpiece, stud bolt and possible matrix is made, the positioning of the stud bolt is finished and the tool is loosened by driving it in the opposite direction for a short while, after which the tool is loosened from the second threaded end of the stud bolt.

In a particularly preferred variant of a tool according to the invention, the threaded part of the tool has a length which is typically between 2 and 5 mm long and which substantially corresponds to one pitch of the screw thread. By such a short thread is achieved the advantage of a rapid engagement with the thread of the stud bolt, and not the least just as rapid release from the threaded end after mounting. The process of mounting stud bolts is further facilitated since the tool, due to the spacer member, acts as a kind of guide for the tool when it is positioned over the end of the stud bolt. When the tool is mounted on a stud bolt, there is contact between bottom of the tool and end of the stud bolt. A steel ball or similar with a smooth and modest surface may be fitted at the bottom of the tool whereby even less resistance has to be overcome when loosening the tool from the stud bolt.

In a variant of a tool according to the invention, the means of the tool for connecting to the drive is mounted on a body part that includes the spacer member and the threaded part. The case is thus about a composite tool consisting of means for connection to a drive, which means can be standardised means for mounting on known types of electric screwdrivers. For example, it may be means for mounting in a drill chuck on an electric screwdriver, but it may also be a square hole for engaging a box wrench tool having e.g. a 0.5 inch square. These means are, as mentioned, mounted on a body part including the spacer member and the threaded part, which may be permanently integrated and joined with the described means for connection to a drive, by welding or by being produced in one piece.

Yet a variant of the tool can be with a body part which is composed of a spacer member and a threaded part, the body part capable of being disassembled, and where the spacer member preferably is modular. By such a solution, a threaded part can be used together with different spacer members so that the same tool can be adapted to different tasks. Alternatively, different tools can be used for different tasks.

As mentioned above, the invention also concerns a method for mounting stud bolts with a tool as described, the method including at least one or more of the following steps: positioning a first threaded end of a stud bolt in or opposite the threaded hole in a workpiece in which the stud bolt is to be mounted; a drive with the tool according to the invention is brought into contact with the second threaded end of the stud bolt, turning the stud bolt into position in the threaded hole in question; the spacer member of the tool bearing on a matrix or on the workpiece; and the direction of rotation of the drive is changed whereby the tool is released from the second threaded end of the stud bolt.

A preferred method according to the invention is that prior to mounting, the stud bolt is disposed in a matrix holding the stud bolt such that the first threaded end is opposite the threaded hole in the workpiece in which the stud bolt is to be mounted. Such a matrix may in this embodiment be a piece including a number of tubes with a given length, where this piece is arranged with the tubes opposite the threaded holes in which the stud bolts are to be mounted. Then it is possible to put the stud bolts into the tubes and subsequently to mount the stud bolts by the tool according to the invention. Such a matrix is particularly useful in connection with mounting stud bolts with appreciable length and maybe diameter as the matrix will thus act as a spacer member between workpiece and the end of the stud bolt. Thus it is not necessary with a large/long spacer member on the tool itself, something which has much influence on the mounting procedure itself as the tool does not have to be passed so far in over the stud bolt, and similarly far in order to get free of the stud bolt after ending mounting. The length projecting from the workpiece after mounting is thus determined by the matrix and the spacer member on the tool. At the same time, the frequently relatively heavy stud bolts may rest in the matrix prior to mounting, why a single operator may perform the mounting where otherwise a fitter for holding the stud bolt as well as a fitter for operating the drive and the tool would be required.

Such an invention may advantageously be applied to mounting of stud bolts that are mounted in threaded bushings embedded in a fibre composite workpiece, where the fibre composite workpiece is a blade for a wind power plant, and where the threaded bushings preferably are embedded at the end of the blade intended for mounting on a hub on a wind power plant. On such blades there are often many stud bolts mounted at the root of the blade, and they are often disposed rather tightly and have an appreciable diameter of e.g. 30-36 mm and with a length of e.g. 400-500 mm. In a single blade with a root diameter of e.g. 1800-3000 mm and with 50-128 embedded threaded bushings, the invention may be applied with advantage, and hereby a significant amount of time may be saved.

### DESCRIPTION OF THE DRAWING

The invention is described in the following with reference to the drawing, wherein:

FIG. 1 shows a cross-section of a tool.

FIG. 2 shows an enlarged detail of the threaded parts.

FIG. 3 shows a workpiece, a stud bolt, a matrix and a tool in cross-section.

### DETAILED DESCRIPTION OF EMBODIMENTS OF THE INVENTION

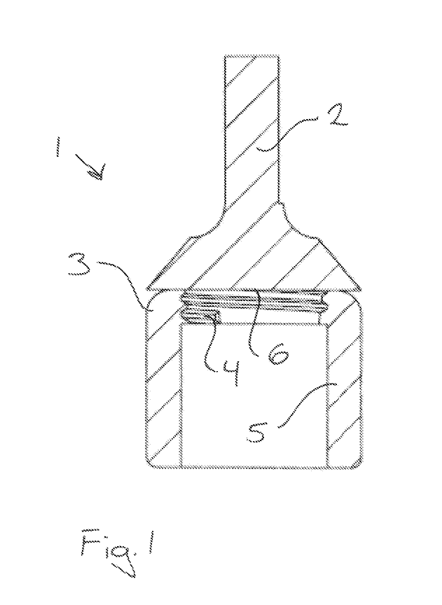

In FIG. 1 is seen a tool 1 according to the invention. The tool is composed of a drive member 2 and a body part 3, the body part 3 including a threaded part 4 and a spacer member 5. The drive member 2 is shown here as a standardised member which can be mounted on body parts 3 with different threaded parts 4 and spacer members 5. The joint between drive member 2 and body part 3 may be effected by any kind of mechanical joining, but welding is the preferred method. By joining the two parts 2 and 3 after making, particularly certain advantages are achieved during the production process for the threaded part 4 in the body part 3. During mounting of a stud bolt, it will be engaged to the threaded part 4 and the end of the stud bolt will be in contact with the bottom 6 in the tool 1.

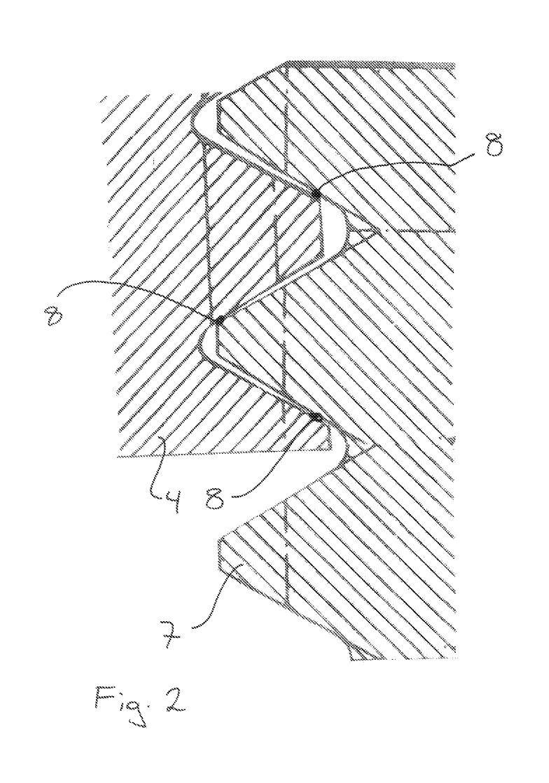

In FIG. 2 appears an enlarged detail of the thread 4 in the tool and of the thread 7 on a stud bolt. It appears that the thread 4 is angled in relation to the thread 7, and therefore there is only very little contact 8 between the two screw threads 4, 7.

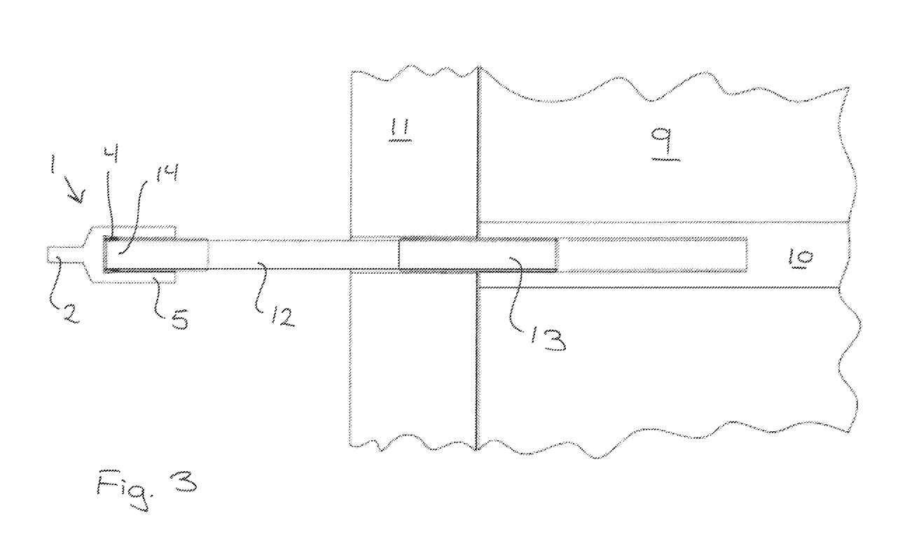

In FIG. 3 is seen schematically a workpiece 9 with an embedded threaded bushing 10. In front of the threaded bushing 10 is arranged a matrix 11 in which a stud bolt 12 is provided with first threaded end 13 which is provided partly in the matrix 11 and in the opening of the threaded bushing. At the other threaded end 14 of the stud bolt, the tool 1 is seen mounted on the stud bolt 12. When the spacer member 5 is in contact with the matrix 11, the stud bolt 12 is mounted at the right position.

1. A tool (1) for mounting a stud bolt (12) with a first threaded end (13) and with a second threaded end (14), where the first threaded end (13) is intended for mounting in threaded holes (10) adapted therefor in a workpiece (9), where the tool (1) is intended for use in connection with a drive, and including a threaded part (4), where the threaded part (4) interacts with the second threaded part (14) of the stud bolt during mounting of the stud bolt (12), characterised in that the threaded part (4) of the tool is made conical, where the conicity has an angle of 5-10°, where the screw thread (4) has the least diameter at the end of the screw thread (4) initially brought into contact with the second end (14) of the stud bolt.

2. Tool according to any of claim 1, characterised in that besides a conical threaded part (4), the tool (1) further includes at least one spacer member (5) and means (2) for connecting to the drive.

3. Tool according to claim 2, characterised in that the threaded part (4) of the tool is made as a conical screw thread, where the outer diameter of the thread as well as the inner diameter of the thread are conical.

4. Tool according to claim 1, characterised in that the threaded part (4) of the tool has a length which is typically between 2 and 5 mm long and which substantially corresponds to one pitch.

5. Tool according to claim 1, characterised in that the means (2) of the tool for connecting to the drive is mounted on a body part (3) including the spacer member (5) and the threaded part (4).

6. Original) Tool according to claim 5, characterised in that the body part (3) of the tool is composed of a spacer member (5) and a threaded part (4), the body part (3) capable of being disassembled, and where the spacer member (5) preferably is composed of modules.

7. A method for mounting stud bolts (12) with a tool (1) according to claim 1, characterised in that the method includes at least one or more of the following steps:
positioning a first threaded end (13) of a stud bolt in or opposite the threaded hole (10) in a workpiece (9) in which the stud bolt (12) is to be mounted;
drive with tool (1) according to the invention is brought into contact with the second threaded end (14) of the stud bolt, turning the stud bolt (12) into position in the threaded hole (10) in question;
the spacer member (5) of the tool bearing on a matrix (11) or on the workpiece (9);
the direction of rotation of the drive is changed whereby the tool (1) is released from the second threaded end (14) of the stud bolt.

8. Method according to claim 7, characterised in that prior to mounting, the stud bolt (12) is placed in a matrix (11) holding the stud bolt (12) such that the first threaded end (13) is opposite the threaded hole (10) in the workpiece (9) in which the stud bolt (12) is to be mounted.

9. Use of a method and a tool (1) for mounting stud bolts (12) according to any of the preceding claims, characterised in that the stud bolts (12) are mounted in threaded bushings (10) embedded in a fibre composite workpiece (9), where the fibre composite workpiece (9) is a blade for a wind power plant, and where the threaded bushings (10) preferably are embedded at the end of the blade intended for mounting on a hub on a wind power plant.

10. Tool according to claim 1, characterised in that the conicity has an angle of about 7°.

11. Tool according to claim 1, characterised in that the drive is a handheld drive.
